(19) United States
(12) Patent Application Publication
(10) Pub. No.: US 2022/0050831 A1
(43) Pub. Date: Feb. 17, 2022

(54) INFORMATION PROCESSING APPARATUS

(71) Applicant: FUJIFILM Business Innovation Corp., Tokyo (JP)

(72) Inventor: Yuya KIDA, Kanagawa (JP)

(73) Assignee: FUJIFILM Business Innovation Corp., Tokyo (JP)

(21) Appl. No.: 17/171,318

(22) Filed: Feb. 9, 2021

(30) Foreign Application Priority Data
Aug. 17, 2020 (JP) 2020-137623

(51) Int. Cl. G06F 16/245

(52) U.S. Cl. CPC G06F 16/245; G06Q 10/1091

(57) ABSTRACT

An information processing apparatus includes a processor configured to classify a data set including plural pieces of data each having a first attribute and a second attribute into plural groups according to a similarity of the first attribute, save, as an intermediate description, a result of processing performed based on a value corresponding to the second attribute, for each of the classified groups, re-save, in a case where the data set is updated, as the intermediate description, the result of processing performed based on the value corresponding to the second attribute for a group including updated data out of the plural groups, and calculate a statistic of the data set based on the saved intermediate description.

### CROSS-REFERENCE TO RELATED APPLICATIONS

This application is based on and claims priority under 35 USC 119 from Japanese Patent Application No. 2020-137623 filed Aug. 17, 2020.

### BACKGROUND

### (i) Technical Field

The present disclosure relates to an information processing apparatus.

### (ii) Related Art

In Japanese Unexamined Patent Application Publication (Translation of PCT Application) No. 2013-506180, a technique for creating intermediate descriptions of saved data and calculating statistics (maximum, minimum, variance, etc.) based on the created intermediate descriptions is described.

### SUMMARY

In known techniques, in the case where intermediate descriptions of a stored data set are created and statistics (maximum, minimum, variance, etc.) are calculated on the basis of the created intermediate descriptions, all the intermediate descriptions have to be created again every time that the data set is updated. Thus, a heavy load is placed on an apparatus that performs creation processing.

Aspects of non-limiting embodiments of the present disclosure relate to reducing the load of processing for calculating statistics, compared to a case where all the intermediate descriptions are created again every time that a data set is updated.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to classify a data set including a plurality of pieces of data each having a first attribute and a second attribute into a plurality of groups according to a similarity of the first attribute, save, as an intermediate description, a result of processing performed based on a value corresponding to the second attribute, for each of the classified groups, re-save, in a case where the data set is updated, as the intermediate description, the result of processing performed based on the value corresponding to the second attribute for a group including updated data out of the plurality of groups, and calculate a statistic of the data set based on the saved intermediate description.

### BRIEF DESCRIPTION OF THE DRAWINGS

Exemplary embodiments of the present disclosure will be described in detail based on the following figures, wherein:

FIG. 1 is a diagram illustrating the entire configuration of a statistical system according to an exemplary embodiment;

FIG. 2 is a diagram illustrating a hardware configuration of an information processing apparatus;

FIG. 3 is a diagram illustrating a hardware configuration of a user terminal;

FIG. 4 is a diagram illustrating a functional configuration in an exemplary embodiment;

FIG. 5 is a diagram illustrating an example of a displayed operation screen for a business system;

FIG. 6 is a diagram illustrating an example of a stored data set;

FIG. 7 is a diagram illustrating an example of saved intermediate descriptions;

FIG. 8 is a diagram illustrating an example of re-saved intermediate descriptions;

FIG. 9 is a diagram illustrating an example of a displayed operation screen for a statistical system;

FIG. 10 is a diagram illustrating an example of displayed statistics;

FIG. 11 is a diagram illustrating an example of an operation procedure of a statistics process;

FIG. 12 is a diagram illustrating an example of a group table;

FIG. 13 is a diagram illustrating another example of the group table;

FIG. 14 is a diagram illustrating an example of a group table used in a modification; and

FIG. 15 is a diagram illustrating another example of the group table used in a modification.

### DETAILED DESCRIPTION

### [1] Exemplary Embodiments

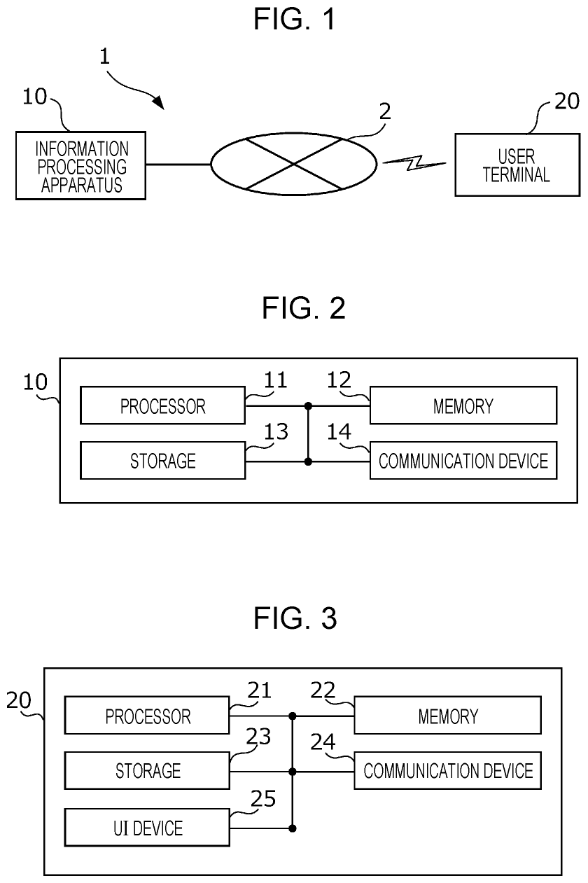

FIG. 1 illustrates the entire configuration of a statistical system 1 according to an exemplary embodiment. The statistical system 1 is a system that calculates statistics from various data sets and presents the statistics to a user. The statistical system 1 includes a communication line 2, an information processing apparatus 10, and a user terminal 20.

The communication line 2 is a communication system including a mobile communication network, the Internet, and the like and relays data exchange between the communication system and an apparatus, a terminal, a system, or the like that communicates with the communication system. The information processing apparatus 10 is connected to the communication line 2 through wired communication, and the user terminal 20 is connected to the communication line 2 through wireless communication. Communication between the communication line 2 and each of the information processing apparatus 10 and the user terminal 20 is not limited to the example illustrated in FIG. 1. The information processing apparatus 10 and the user terminal 20 may be connected to the communication line 2 through wired communication or wireless communication.

The information processing apparatus 10 performs processing for presenting statistics to a user. Statistics are values obtained by applying statistical functions to a data set, which is a group of sample data, and represent characteristics of the data set. The user terminal 20 is a terminal used by a user who wishes to obtain statistics. The user terminal 20 includes a display. Statistics calculated by the information processing apparatus 10 are displayed on the display of the user terminal 20.

FIG. 2 illustrates a hardware configuration of the information processing apparatus 10. The information processing apparatus 10 is a computer that includes a processor 11, a memory 12, a storage 13, and a communication device 14. The processor 11 includes, for example, an arithmetic unit such as a central processing unit (CPU), a register, a peripheral circuit, and the like. The memory 12 is a recording medium readable by the processor 11 and includes a random access memory (RAM), a read only memory (ROM), and the like.

The storage 13 is a recording medium readable by the processor 11 and includes, for example, a hard disk drive or a flash memory. The processor 11 controls an operation of each hardware item by using the RAM as a work area and executing a program stored in the ROM or the storage 13. The communication device 14 is communication means including an antenna, a communication circuit, and the like. The communication device 14 functions as communication means for performing communication through the communication line 2.

FIG. 3 illustrates a hardware configuration of the user terminal 20. The user terminal 20 is a computer that includes a processor 21, a memory 22, a storage 23, a communication device 24, and a user interface (UI) device 25. The processor 21, the memory 22, the storage 23, and the communication device 24 are hardware items of the same type as the processor 11, the memory 12, the storage 13, and the communication device 14 illustrated in FIG. 2.

The UI device 25 is an interface that is provided to a user of the user terminal 20. The UI device 25 includes, for example, a touch screen including a display as display means and a touch panel provided on the surface of the display. The UI device 25 displays images and receives operation performed by the user. The UI device 25 also includes an operator such as a keyboard and receives operation performed on the operator.

In the statistical system 1, functions described below are implemented when the processors of the apparatuses mentioned above execute a program and control the units mentioned above. An operation performed by a function is also represented as an operation performed by a processor of a corresponding apparatus that implements the function.

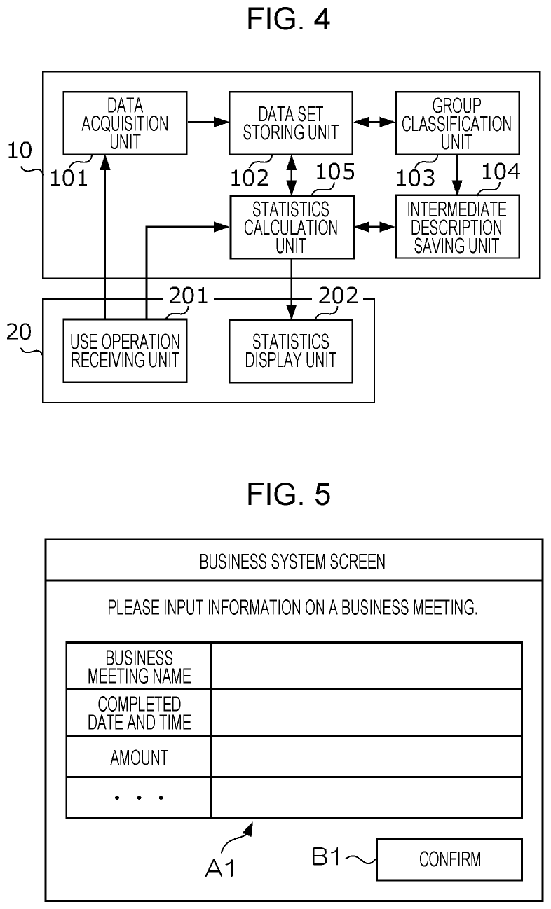

FIG. 4 illustrates a functional configuration implemented in an exemplary embodiment. The information processing apparatus 10 includes a data acquisition unit 101, a data set storing unit 102, a group classification unit 103, an intermediate description saving unit 104, and a statistics calculation unit 105. The user terminal 20 includes a use operation receiving unit 201 and a statistics display unit 202.

The use operation receiving unit 201 of the user terminal 20 receives an operation by the user for using the statistical system 1. The use operation receiving unit 201 displays an operation screen for receiving a use operation. In this exemplary embodiment, the use operation receiving unit 201 displays an operation screen for a business system for managing a business meeting with a customer and an operation screen for a statistical system for presenting statistics to the user.

FIG. 5 illustrates an example of a displayed operation screen for a business system. In the example illustrated in FIG. 5, the use operation receiving unit 201 displays a business system screen indicating a character string “Please input information on a business meeting.”, an input field A1 for input items such as “business meeting name”, “completed date and time”, and “amount”, and a confirm button B1. When an operation for pressing the confirm button B1 is performed with character stings input in the input field A1, the use operation receiving unit 201 transmits business meeting data indicating the input character strings regarding the business meeting to the information processing apparatus 10.

The data acquisition unit 101 of the information processing apparatus 10 acquires data including two or more attributes. In this exemplary embodiment, the data acquisition unit 101 acquires, as data including two or more attributes, business meeting data of input items illustrated in FIG. 5. The business meeting data includes two or more attributes, such as “business meeting name”, “completed date and time”, and “amount”. The data acquisition unit 101 supplies the acquired data to the data set storing unit 102.

The data set storing unit 102 stores a data set including supplied data, that is, data acquired by the data acquisition unit 101.

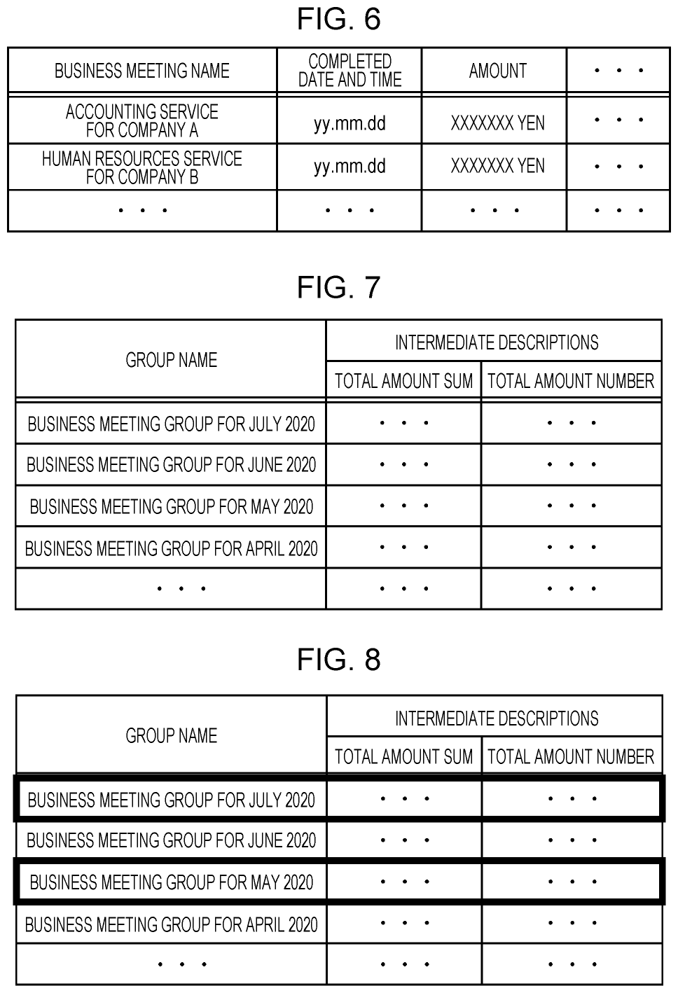

FIG. 6 illustrates an example of a stored data set. In the example illustrated in FIG. 6, the data set storing unit 102 stores business meeting names “accounting service for Company A” and “human resources service for Company B” and corresponding completed dates and times and amounts in associated with each other.

The group classification unit 103 classifies a data set stored in the data set storing unit 102 into a plurality of groups. Specifically, the group classification unit 103 classifies a data set including a first attribute and a second attribute into a plurality of groups according to similarity of the first attribute. For example, in the case where “completed date and time” is defined as the first attribute, the group classification unit 103 classifies data with the same completed month into the same group.

For example, every time storing new data for updating a data set, the data set storing unit 102 notifies the group classification unit 103 of update of the data set. When receiving the notification, the group classification unit 103 reads the data set from the data set storing unit 102 and performs group classification. In the case where a data set is stored for the first time, the group classification unit 103 classifies all the pieces of data into corresponding groups.

In the case where new data is stored as a data set, the group classification unit 103 classifies the new data into a group to which the new data is to belong or classifies the new data into a new group if there is no group to which the new data is to belong. The group classification unit 103 supplies identification information (for example, a group name) for identifying a classified group to the intermediate description saving unit 104.

The intermediate description saving unit 104 stores, as an intermediate description, a result of processing obtained based on a value corresponding to the second attribute mentioned above, for each group indicated by supplied identification information, that is, each group classified by the group classification unit 103. In this exemplary embodiment, the intermediate description saving unit 104 saves, as intermediate descriptions, the total sum and total number of values corresponding to the second attribute. More particularly, in this exemplary embodiment, in the case where the first attribute is “completed date and time”, “amount” is defined as the second attribute. The intermediate description saving unit 104 generates, as intermediate descriptions, the total sum and total number of values corresponding to the item “amount”, and saves the generated intermediate descriptions.

FIG. 7 illustrate an example of saved intermediate descriptions. In the example illustrated in FIG. 7, the intermediate description saving unit 104 saves, as intermediate descriptions, the total sum of amounts and the total number of amounts in association with group names such as “business meeting group for July 2020”, “business meeting group for June 2020”, “business meeting group for May 2020”, and “business meeting group for April 2020”. As described above, saving of intermediate descriptions is performed every time that a data set is updated by new data.

In the case where a data set is updated, the intermediate description saving unit 104 re-saves, as intermediate descriptions, the total sum and total number of values corresponding to the second attribute for a group including the updated data out of a plurality of groups. Furthermore, in the case where a data set is updated, the intermediate description saving unit 104 does not re-save intermediate descriptions for a group not including the update data out of the plurality of groups.

FIG. 8 illustrates an example of re-saved intermediate descriptions. In the example illustrated in FIG. 8, only data of “business meeting group for July 2020” and “business meeting group for May 2020” are updated. In this case, the intermediate description saving unit 104 re-saves intermediate descriptions for only the “business meeting group for July 2020” and “business meeting group for May 2020” and does not re-save intermediate descriptions for the other groups. Groups for which intermediate descriptions are re-saved are surrounded by bold lines in FIG. 8.

When creating a business plan for a department, a user may obtain statistics regarding past business meetings to capture the trend of business meetings. In such a case, the user operates the user terminal 20 to display an operation screen for the statistical system.

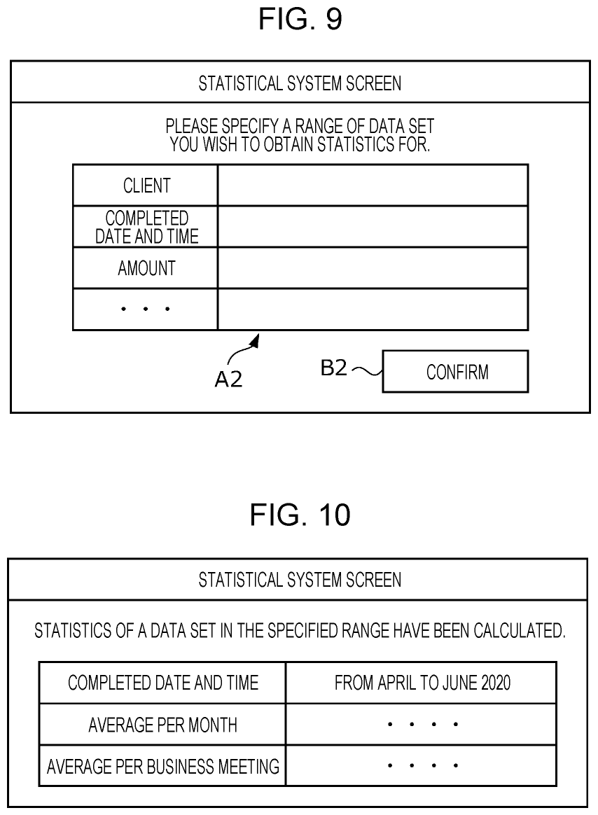

FIG. 9 illustrates an example of a displayed operation screen for the statistical system. In the example illustrated in FIG. 9, the use operation receiving unit 201 displays a statistical system screen indicating a character string “Please specify a range of data set you wish to obtain statistics for.”, a specification field A2 for specifying a range of data set regarding a business meeting name, a completed date and time, and an amount, and a confirm button B2.

When an operation for pressing the confirm button B2 is performed with a range of data set specified in the specification field A2, the use operation receiving unit 201 transmits range data indicating the specified range to the information processing apparatus 10. The statistics calculation unit 105 of the information processing apparatus 10 calculates statistics of the data set in the range, on the basis of intermediate descriptions saved for the range of data set indicated by the transmitted range data.

For example, In the case where the intermediate descriptions illustrated in FIG. 8 are saved and the range of data set such as “from April to June 2020” is specified, the statistics calculation unit 105 calculates statistics based on the intermediate descriptions for “business meeting group for June 2020”, “business meeting group for May 2020”, and “business meeting group for April 2020”. For example, the statistics calculation unit 105 calculates an average per month as a statistic by adding up the total sums for April, May, and June and dividing the added total sums by 3.

Furthermore, the statistics calculation unit 105 calculates an average per business meeting as a statistic by adding up the total sums for April, May, and June and dividing the added total sums by the value obtained by adding up the total numbers for April, May, and June. In the example mentioned above, a specified range and group classification match. However, a specified range and group classification may not match. For example, a specified range and group classification do not match in the case where a range from Apr. 16, 2020 to Jul. 15, 2020 is specified.

In this case, for example, the statistics calculation unit 105 calculates a value corresponding to a prorated value for fifteen days based on the total sums for April and July. For April, the statistics calculation unit 105 calculates a value by multiplying 15 days by a value obtained by dividing the total sum by 30 days. For July, the statistics calculation unit 105 calculates a value by multiplying 15 days by a value obtained by dividing the total sum by 31 days. The statistics calculation unit 105 calculates statistics based on the calculated total sums for April and July and the total sums for May and June. In the case mentioned above, the statistics calculation unit 105 may calculate statistics by directly using intermediate descriptions for the April group and the July group.

The statistics calculation unit 105 transmits statistics data indicating calculated statistics to the user terminal 20. The statistics display unit 202 of the user terminal 20 displays statistics indicated by the transmitted statistics data.

FIG. 10 illustrates an example of displayed statistics. In the example illustrated in FIG. 10, the statistics display unit 202 displays a statistical system screen indicating a character string “Statistics of a data set in the specified range have been calculated.”, the range of data set, and “average per month” and “average per business meeting”, which are statistics.

The apparatuses included in the statistical system 1 perform, with the configurations mentioned above, a statistics process for calculating statistics.

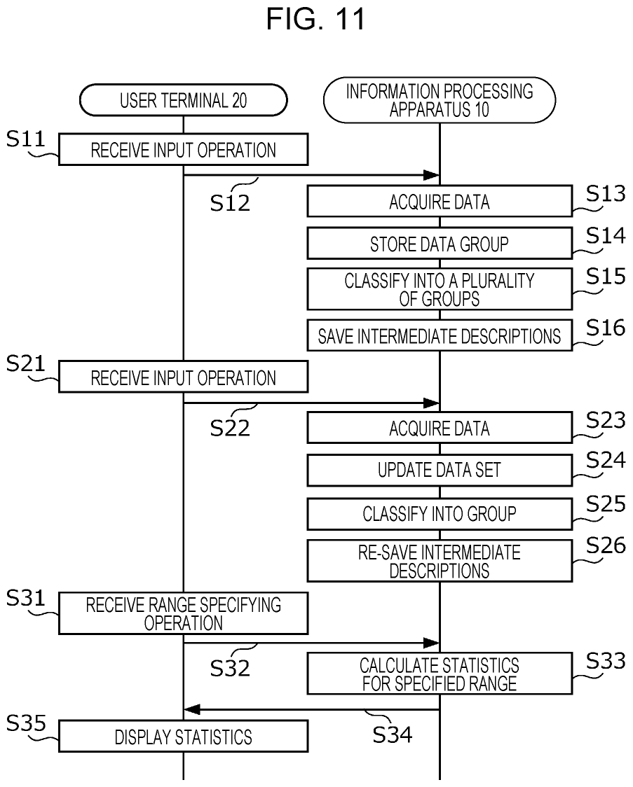

FIG. 11 illustrates an example of an operation procedure of a statistics process. First, the user terminal 20 (use operation receiving unit 201) receives an operation for inputting data (step S11), and transmits the data (in this exemplary embodiment, business meeting data) input by the received input operation to the information processing apparatus 10 (step S12).

The information processing apparatus 10 (data acquisition unit 101) acquires the transmitted data as data including two or more attributes (step S13). Next, the information processing apparatus 10 (data set storing unit 102) stores a data set including the acquired data (step S14). Then, the information processing apparatus 10 (group classification unit 103) classifies the stored data set into a plurality of groups according to similarity of the first attribute (step S15).

Next, the information processing apparatus 10 (intermediate description saving unit 104) saves, for each of the plurality of classified groups, the total sum and total number of values corresponding to the second attribute as intermediate descriptions (step S16). Next, the user terminal 20 (use operation receiving unit 201) receives an operation for inputting new data for updating the data set (step S21), and transmits the update data input by the received input operation to the information processing apparatus 10 (step S22).

The information processing apparatus 10 (data acquisition unit 101) acquires the transmitted update data (step S23). Next, the information processing apparatus 10 (data set storing unit 102) updates the data set by storing the acquired update data (step S24). Then, the information processing apparatus 10 (group classification unit 103) classifies the update data into a corresponding group (step S25).

The information processing apparatus 10 (intermediate description saving unit 104) re-saves, as intermediate descriptions, the total sum and total number of values corresponding to the second attribute for the group including the updated data out of the plurality of groups (step S26). Next, the user terminal 20 (use operation receiving unit 201) receives an operation for specifying the range of data for which statistics are to be calculated (step S31), and transmits range data indicating the range specified by the received specifying operation (step S32).

The information processing apparatus 10 (statistics calculation unit 105) calculates statistics of a data set in the range on the basis of the intermediate descriptions stored for the range of data set indicated by the transmitted range data (step S33). Next, the information processing apparatus 10 (statistics calculation unit 105) transmits statistics data indicating the calculated statistics to the user terminal 20 (step S34). The user terminal 20 (statistics display unit 202) displays the statistics indicated by the transmitted statistics data (step S35).

In this exemplary embodiment, a data set is classified into a plurality of groups and intermediate descriptions for only an updated group are re-saved. Thus, for example, compared to a case where all the intermediate descriptions are created again every time that a data set is updated, the load of processing for calculating statistics is reduced.

### [2] Modifications

The exemplary embodiment described above is merely an example of an exemplary embodiment of the present disclosure. The foregoing exemplary embodiment may be modified as described below. Furthermore, exemplary embodiments and modifications may be combined together where necessary.

### [2-1] Group Classification Method

The group classification unit 103 may perform group classification in a method different from that used in the exemplary embodiment described above. For example, the group classification unit 103 may increase or decrease the number of groups according to characteristics of a data set. Characteristics of a data set may be, for example, the number of pieces of data included in the data set. In this case, for example, the group classification unit 103 performs classification such that the number of groups decreases as the number of pieces of data increases. The group classification unit 103 determines the number of groups by referring to a group table in which correspondence between the number of pieces of data and the number of groups is set.

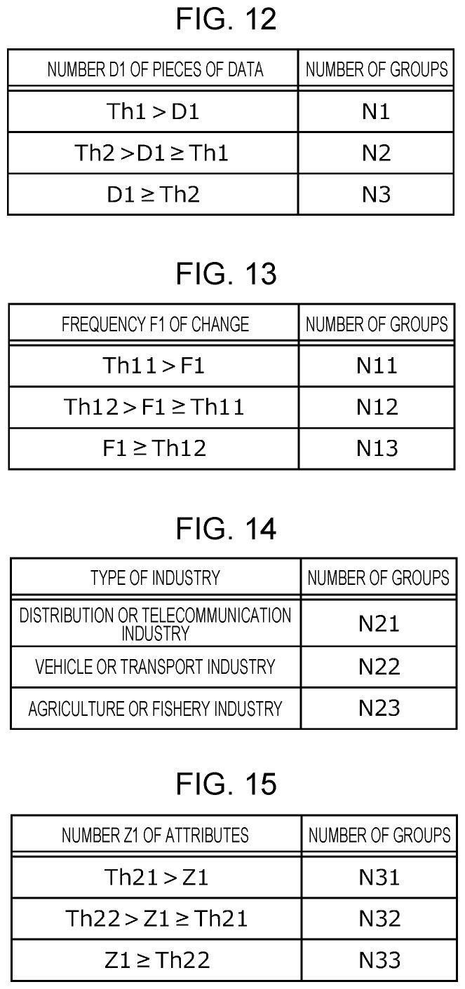

FIG. 12 illustrates an example of a group table. In the example illustrated in FIG. 12, the correspondence between the number D1 of pieces of data and the number of groups is set as follows: “Th1>D1” is associated with “N1”, “Th2>D1≥Th1” is associated with “N2”, and “D1≥Th2” is associated with “N3”, where N1 is more than N2, and N2 is more than N3. For example, in the case where the number of pieces of data is less than Th1, the group classification unit 103 performs classification into N1 groups. In the case where the number of pieces of data is equal to or more than Th2, the group classification unit 103 performs classification into N3 groups, which is less than N1 groups.

As the number of pieces of data belonging to a group increases, the probability that update data is included in the group increases, the number of intermediate descriptions to be re-saved increases, and the load of processing is likely to increase. Thus, in a modification, as the number of pieces of data included in a data set increases, the number of groups decreases. Therefore, compared to the case where the number of groups is fixed, the number of intermediate descriptions to be re-saved is likely to be small, and the load of processing is suppressed from increasing.

Characteristics of a data set may be the frequency of change to the data set. In this case, the group classification unit 103 performs group classification such that the number of groups decreases as the frequency of change to a data set increases. The group classification unit 103 determines the number of groups by referring to a group table in which correspondence between the frequency of change and the number of groups is set.

FIG. 13 illustrates another example of the group table. In the example illustrated in FIG. 13, the correspondence between the frequency F1 of change and the number of groups is set as follows: “Th11>F1” is associated with “N11”, “Th12>F1≥Th11” is associated with “N12”, and “F1≥Th12” is associated with “N13”, where N11 is more than N12, and N12 is more than N13. For example, in the case where the frequency F1 of change is less than Th11, the group classification unit 103 performs classification into N11 groups. In the case where the frequency F1 of change is equal to or more than Th12, the group classification unit 103 performs classification into N13 groups, which is less than N11 groups.

As the frequency of change to a data set increases, the number of intermediate descriptions to be re-saved increases, and the load of processing is likely to increase. Thus, in a modification, as the frequency of change to a data set increases, the number of groups decreases. Therefore, compared to the case where the number of groups is fixed, the number of intermediate descriptions to be re-saved is likely to be small, and the load of processing is suppressed from increasing.

### [2-2] Characteristics of Data

The group classification unit 103 may perform group classification in a method different from that used in each of the examples mentioned above. For example, the group classification unit 103 may increase or decrease the number of groups in accordance with characteristics of each piece of data included in a data set. For example, in the case where a data set includes a value indicating a corporate activity (completed date and time, amount, etc.) as in an exemplary embodiment described above, the type of business that performs the corporate activity is used as characteristics of each piece of data.

In this case, the group classification unit 103 performs classification such that the number of groups decreases as the degree of detailedness of statistics of a data set required for a type of industry increases. The group classification unit 103 performs classification by referring to a group table in which correspondence between the type of industry and the number of groups is set.

FIG. 14 illustrates an example of a group table used in a modification. In the example illustrated in FIG. 14, the correspondence between a type of industry and the number of groups is set as follows: “distribution or telecommunication industry” is associated with “N21”, “vehicle or transport industry” is associated with “N22”, and “agriculture or fishery industry” is associated with “N23”, where N21 is less than N22, and N22 is less than 23.

For example, in the case where the type of industry is a distribution industry or a telecommunication industry, the group classification unit 103 performs classification into N21 groups. In the case where the type of industry is a vehicle or transport industry, the group classification unit 103 performs classification into N22 groups, which is more than N21. Furthermore, in the case where the type of industry is an agriculture or fishery industry, the group classification unit 103 performs classification into N23 groups, which is more than N22.

Statistics such as sales number or average spending per customer may be used to set prices of products or services. The distribution industry and the telecommunication industry are types of industry that serves a large number of general consumers one by one and the average spending per customer is not high. Thus, to achieve competitive and profitable pricing, detailed statistics are required. In contrast, for the vehicle and transport industries, average spending per customer is high, and statistics may not be as detailed as those for the distribution industry and the telecommunication industries.

Furthermore, the agriculture and fishery industries deal with nature, and detailed statistics are not able to be made use of. Thus, statistics may not be as detailed as those for other industries. A type of industry that requires more detailed statistics is likely to have more pieces of data, and the frequency of update of data is likely to be increased as the number of pieces of data increases. Thus, the number of intermediate descriptions to be re-saved increases, and the load of processing is likely to increase.

Thus, in a modification, for a type of industry that requires more detailed statistics, classification is performed into a smaller number of groups. Accordingly, compared to the case where the number of groups is fixed, the number of intermediate descriptions to be re-saved is likely to be small, and the load of processing is suppressed from increasing. A reduction in the number of groups does not affect statistics eventually calculated. Thus, levels of detailedness of statistics required for types of industries may be satisfied.

When the intermediate description saving unit 104 creates an intermediate description based on an attribute as the second attribute that is different from the first attribute, characteristics of data may be the number of attributes of the data. In this case, for example, the group classification unit 103 may perform classification by referring to a group table in which correspondence between the number of attributes of data and the number of groups is set.

FIG. 15 illustrates another example of the group table used in a modification. In the example illustrated in FIG. 15, correspondence between the number Z1 of attributes and the number of groups is set as follows: “Th21>Z1” is associated with “N31”, “Th22>Z1≥Th21” is associated with “N32”, and “Z1≥Th22” is associated with “N33”, where N31 is larger than N32, and N32 is larger than N33. For example, in the case where the number Z1 of attributes is less than Th21, the group classification unit 103 performs classification into N31 groups. In the case where the number Z1 of attributes is equal to or more than Th22, the group classification unit 103 performs classification into N33, which is less than N31.

As the number of attributes of data increases, the number of second attributes from which statistics are able to be calculated increases, and more intermediate descriptions are created. Thus, in this modification, the group classification unit 103 performs classification such that the number of groups decreases as the number of attributes increases. Accordingly, compared to the case where the number of groups is fixed, the number of intermediate descriptions to be re-saved is likely to be small, and the load of processing is suppressed from increasing.

### [2-3] Direction of Increase or Decrease in Number of Groups

In each of the examples mentioned above, the load of processing is likely to increase as the number of intermediate descriptions to be re-saved increases. Thus, the number of groups is reduced so that the load of processing is suppressed from increasing. In contrast, however, increasing the number of groups may suppress the load of processing from increasing.

For example, as the number of pieces of update data included in a group increases, the load of processing for re-saving intermediate descriptions may increase quadratically. In such a case, even if the number of intermediate descriptions to be re-saved increases, decreasing the number of pieces of update data included in a group suppresses the load of processing from increasing, compared to the case where the number of groups is fixed.

In the case mentioned above, for example, the group classification unit 103 performs classification such that the number of groups increases as the number of pieces of data increases and the number of groups increases as the frequency of change to a data set increases. Furthermore, the group classification unit 103 may perform classification such that the number of groups increases as the degree of detailedness of statistics of a data set required for a type of industry increases or the number of groups decreases as the number of attributes increases. In any case, compared to the case where the number of groups is fixed, the load of processing is suppressed from increasing.

### [2-4] Functional Configuration

The functional configuration implemented by the information processing apparatus 10 is not limited to that illustrated in FIG. 4. For example, although the intermediate description saving unit 104 creates and saves intermediate descriptions in an exemplary embodiment, creation and saving of intermediate descriptions may be implemented by different functions.

Furthermore, for example, operations performed by the data acquisition unit 101 and the data set storing unit 102 may be implemented by a single function. Furthermore, a function implemented by the information processing apparatus 10 may be implemented by two or more information processing apparatuses or a computer resource provided by a cloud service. In short, ranges of operations that are implemented by functions and apparatuses that implement functions may be set in a desired manner as long as the functions illustrated in FIG. 4 are implemented as a whole.

### [2-5] Processor

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

### [2-6] Category of Disclosure

The present disclosure may be regarded as an information processing apparatus including a user terminal, an information processing method for implementing a process performed by the information processing apparatus, and a program for causing a computer controlling the information processing apparatus to function. The program may be provided in a form of a recording medium such as an optical disc in which the program is recorded or may be provided in a form downloaded into a computer via a communication line such as the Internet and installed so that the program is able to be used.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
classify a data set including a plurality of pieces of data each having a first attribute and a second attribute into a plurality of groups according to a similarity of the first attribute,
save, as an intermediate description, a result of processing performed based on a value corresponding to the second attribute, for each of the classified groups,
re-save, in a case where the data set is updated, as the intermediate description, the result of processing performed based on the value corresponding to the second attribute for a group including updated data out of the plurality of groups, and
calculate a statistic of the data set based on the saved intermediate description.

2. The information processing apparatus according to claim 1, wherein the processor is configured to increase or decrease a number of groups in accordance with characteristics of the data set.

3. The information processing apparatus according to claim 2, wherein the characteristics of the data set include a number of pieces of data included in the data set, and the processor is configured to perform the classification such that the number of groups decreases as the number of pieces of data increases.

4. The information processing apparatus according to claim 2, wherein the characteristics of the data set include a frequency of change to the data set, and the processor is configured to perform the classification such that the number of groups decreases as the frequency increases.

5. The information processing apparatus according to claim 1, wherein the processor is configured to increase or decrease a number of groups in accordance with characteristics of each of the plurality of pieces of data included in the data set.

6. The information processing apparatus according to claim 2, wherein the processor is configured to increase or decrease the number of groups in accordance with characteristics of each of the plurality of pieces of data included in the data set.

7. The information processing apparatus according to claim 3, wherein the processor is configured to increase or decrease the number of groups in accordance with characteristics of each of the plurality of pieces of data included in the data set.

8. The information processing apparatus according to claim 4, wherein the processor is configured to increase or decrease the number of groups in accordance with characteristics of each of the plurality of pieces of data included in the data set.

9. The information processing apparatus according to claim 5, wherein the data set includes a value indicating a corporate activity, the characteristics of each of the plurality of pieces of data include a type of industry of a business that performs the corporate activity, and the processor is configured to perform the classification such that the number of groups decreases as the degree of detailedness of statistics of the data set required for the type of industry increases.

10. The information processing apparatus according to claim 6, wherein the data set includes a value indicating a corporate activity, the characteristics of each of the plurality of pieces of data include a type of industry of a business that performs the corporate activity, and the processor is configured to perform the classification such that the number of groups decreases as the degree of detailedness of statistics of the data set required for the type of industry increases.

11. The information processing apparatus according to claim 7, wherein the data set includes a value indicating a corporate activity, the characteristics of each of the plurality of pieces of data include a type of industry of a business that performs the corporate activity, and the processor is configured to perform the classification such that the number of groups decreases as the degree of detailedness of statistics of the data set required for the type of industry increases.

12. The information processing apparatus according to claim 8, wherein the data set includes a value indicating a corporate activity, the characteristics of each of the plurality of pieces of data include a type of industry of a business that performs the corporate activity, and the processor is configured to perform the classification such that the number of groups decreases as the degree of detailedness of statistics of the data set required for the type of industry increases.

13. The information processing apparatus according to claim 5, wherein characteristics of each of the plurality of pieces of data include a number of attributes of the data, and the processor is configured to perform the classification such that the number of groups decreases as the number of attributes increases.

14. The information processing apparatus according to claim 6, wherein characteristics of each of the plurality of pieces of data include a number of attributes of the data, and the processor is configured to perform the classification such that the number of groups decreases as the number of attributes increases.

15. The information processing apparatus according to claim 7, wherein characteristics of each of the plurality of pieces of data include a number of attributes of the data, and the processor is configured to perform the classification such that the number of groups decreases as the number of attributes increases.

16. The information processing apparatus according to claim 8, wherein characteristics of each of the plurality of pieces of data include a number of attributes of the data, and the processor is configured to perform the classification such that the number of groups decreases as the number of attributes increases.

17. An information processing apparatus comprising:
means for classifying a data set including a plurality of pieces of data each having a first attribute and a second attribute into a plurality of groups according to a similarity of the first attribute,
means for saving, as an intermediate description, a result of processing performed based on a value corresponding to the second attribute, for each of the classified groups,
means for re-saving, in a case where the data set is updated, as the intermediate description, the result of processing performed based on the value corresponding to the second attribute for a group including updated data out of the plurality of groups, and
means for calculating a statistic of the data set based on the saved intermediate description.
